(19) United States
(12) Patent Application Publication
(10) Pub. No.: US 2012/0158290 A1
(43) Pub. Date: Jun. 21, 2012

(54) Navigation User Interface

(75) Inventors: Aarti Bharathan, Redmond, WA (US); Liang Chen, Bellevue, WA (US); Jae Pum Park, Bellevue, WA (US)

(73) Assignee: Microsoft Corporation, Redmond, WA (US)

(21) Appl. No.: 12/972,389

(22) Filed: Dec. 17, 2010

(51) Int. Cl. G01C 21/36

(52) U.S. Cl. 701/425; 701/437

(57) ABSTRACT

A navigation user interface displays a route to be navigated over a road view map. If a user selects a particular segment of the displayed route, text-based directions associated with the particular route segment are displayed, with a selectable area to return to the map view. Additionally, as the road view map is zoomed in, when the zoom level reaches a threshold zoom level, the navigation user interface automatically transitions to displaying a satellite view map overlaid with at least a portion of the route to be navigated.

### BACKGROUND

Many mobile devices now come equipped with global positioning system (GPS) capabilities, enabling a user to use the mobile device to get real-time directions to a location. Such directions are often presented as a graphical map and/or as text-based directions. However, navigating between a graphical map presentation and a text-based presentation can be cumbersome, which is not desirable, especially while driving. Furthermore, most graphical map presentations for providing navigation directions are illustrations, and do not provide a lot of contextual data for a particular area.

### SUMMARY

This document describes a navigation user interface. In one aspect, the navigation user interface provides a seamless transition from a road view map to a satellite view map based on a current zoom level. In another aspect, the navigation user interface enables a user to easily transition between a map view and a text view of a navigation route.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The term “techniques,” for instance, may refer to device(s), system(s), method(s) and/or computer-readable instructions as permitted by the context above and throughout the document.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to reference like features and components.

FIG. 1 is a pictorial diagram of an example environment in which a navigation user interface may be implemented.

FIG. 2 is a block diagram that illustrates components of an example mobile navigation device configured to implement a navigation user interface.

FIG. 3 is a block diagram that illustrates components of an example user interface module of a navigation application.

FIG. 4 is a flow diagram of an example process for presenting a navigation user interface.

### DETAILED DESCRIPTION

Mobile device navigation systems can be cumbersome to navigate, especially while traveling a particular route. For example, a user may want to toggle between a map view of a route and a text view of navigation directions, without having to navigate a menu system. Furthermore, a user may want to quickly move from a map view to a text view associated with a particular point along a mapped route.

Additionally, while navigating a route based on a displayed map view, as a user nears the destination, traditional map views do not provide a lot of contextual information regarding the surroundings. However, with the ever increasing availability of satellite imagery, replacing a traditional map view with a satellite view of an area near a destination provides the user with more useful context information. For example, when a user comes within one-half mile of a destination, viewing a satellite image of the area instead of a traditional map view will provide additional clues to the user regarding the surroundings. Satellite images include buildings and accurate color—two things that are not found in traditional map views.

A navigation user interface as describe herein provides an effective technique for quickly navigating between a map view of a route and a text view of navigation directions. The navigation user interface also provides functionality by which a traditional map view is automatically transitioned to a satellite view as a user, using a mobile navigation device, nears a destination.

### Example Environment

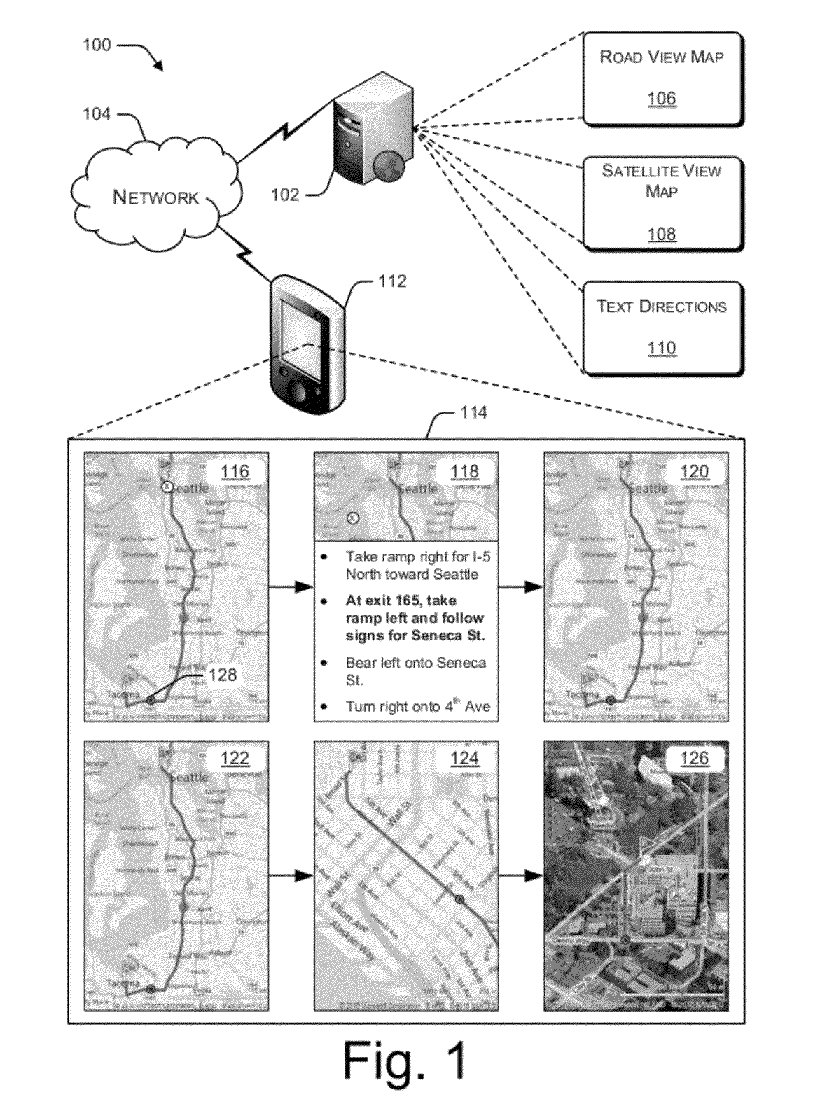

FIG. 1 illustrates an example environment 100 usable to implement a navigation user interface as described herein. Example environment 100 includes a server 102 that serves a map data over a network 104, such as, for example, the Internet. The map data may include, but is not limited to, a road view map 106, a satellite view map 108, and/or text directions 110.

Various types of network capable mobile navigation devices, represented by mobile phone 112, are configured to access the map data over the network 104. For example, a mobile phone 112 may be configured to track a position of the mobile phone 112 using a GPS (global positioning system) and to request directions to a particular destination. In an example implementation, the request for directions to the particular destination is sent over network 104 to server 102. The requested directions may be based on a current location of the mobile phone as the starting point, or may be based, for example, on a user-specified location.

In response to the request for directions, any combination of road view map data 106, satellite view map data 108, and/or text directions 110 are sent by the server 102 over network 104 to mobile phone 112. Using a navigation application, mobile phone 112 presents the received directions through a user interface 114. Screen displays 116-126 illustrate example ways in which the received directions may be provided through user interface 114.

Screen displays 116-120 illustrate user directed navigation between a map view and a text view of the requested directions. Screen display 116 illustrates a road view map 106 that shows a route, for example, from Tacoma to the Space Needle in Seattle, Wash. In screen display 116, the dark filled circle 128 is a current location indicator. If a user selects any point along the displayed route, then screen display 118 is generated. For example, screen display 118 may be displayed in response to a user selecting the location on the route displayed in screen display 116 as indicated by the circle-X through, for example, a touch screen.

In an example implementation, screen display 118 includes an area for presenting text-based directions, and a selectable area for navigating back to the map view. In the illustrated example, the portion of the text-based directions that corresponds to the specific route segment selected by the user from screen display 116 is highlighted by a bold font. In alternate implementations, the specific selected route segment may be highlighted in any number of ways. Alternatively, screen display 118 may display only the specific text directions associated with the selected route segment.

When a user selects the selectable area for navigating back to the map view, screen display 120 is generated. For example, if the user selects any location on the small map of screen display 118, as indicated by the circle-X, (even a location that is not on the displayed route) screen display 120 is presented.

Screen displays 122-126 illustrate automatic transition between a road view map and a satellite view map based on a degree of zoom. For example, the transition from screen display 122 to 124 illustrate that as the mobile phone moves along the displayed route, the displayed map is automatically zoomed in. For example, the map may be zoomed in such that at any time, the displayed map is zoomed in as much as possible while still displaying both the destination and the current location indicator.

The transition from screen display 124 to 126 illustrates that as the mobile phone moves sufficiently close to the destination, in addition to zooming in, the displayed map transitions from a road view map to a satellite view map.

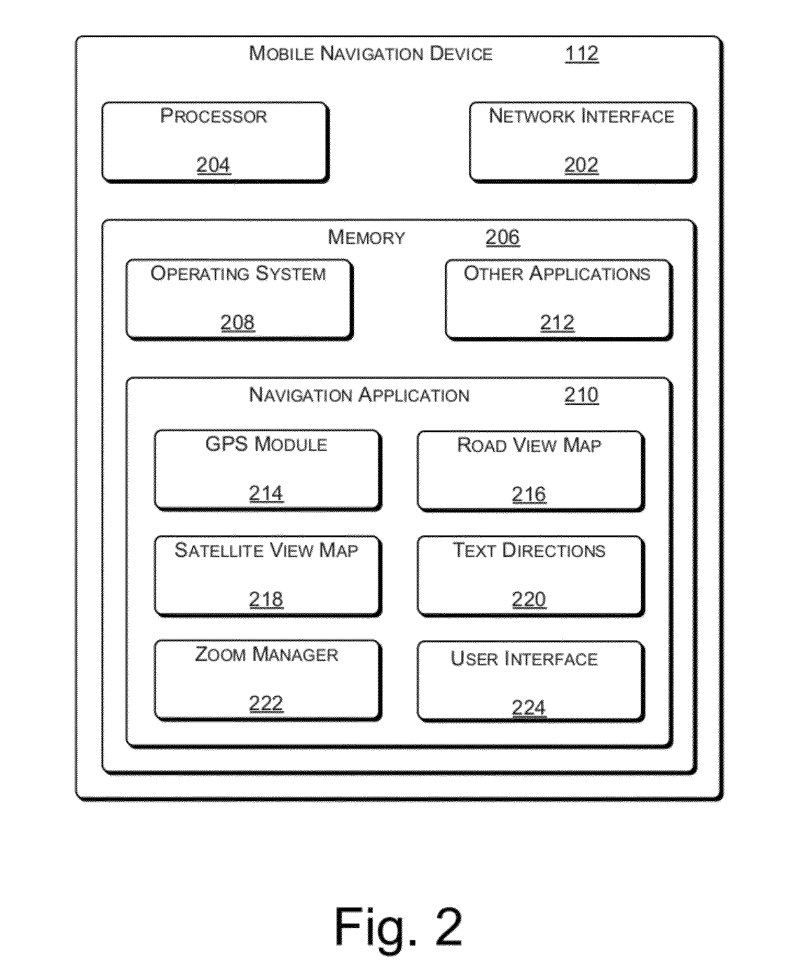

FIG. 2 illustrates components of an example mobile navigation device 112. As described above mobile phone 112 is representative of any mobile navigation device configured to implement the techniques described herein. Example mobile navigation device 112 includes one or more network interfaces 202, processor 204, and memory 206. Network interface 202 enables mobile navigation device 112 to communication with other devices, such as server 102 over network 104.

An operating system 208, a navigation application 210, and one or more other applications 212 are stored in memory 206 as computer-readable instructions, and are executed, at least in part, on processor 204.

Navigation application 210 includes a global positioning system (GPS) module 214, a road view map 216, a satellite view map 218, text directions 220, a zoom manager 222, and user interface 224. GPS module 214 is configured to maintain a current location of the mobile navigation device.

Road view map 216 is configured to store at least a portion of a road view map that includes a route between a starting point and a destination, and can be displayed as a foundation for presenting GPS information to a user. Similarly, Satellite view map 218 is configured to store at least a portion of a satellite view map that includes a least a portion of a route between the starting point and the destination, and can also be displayed as a foundation for presenting GPS information to a user.

Text directions 220 are a textual representation of a route between a starting point and a destination. Text directions 220 typically correspond to the route included in the road view map 216 and satellite view map 218.

Zoom manager 222 controls a zoom level to be applied at any particular time to road view map 216 and/or satellite view map 218. Zoom levels may be defined in any number of ways. For example, percentages may be used to represent zoom levels such that a 0% zoom is the broadest view available, and a 100% zoom is the most detailed view available. Zoom manager 222 maintains an indication of a zoom level at which navigation application 210 is configured to automatically transition from a road view map to a satellite view map. The transition zoom level may be pre-configured for the mobile navigation device 112 or it may be a user-configurable value. For example, zoom manager 222 may store a transition zoom level equal to 90%, indicating that when a road view map is zoomed into a zoom level of 90%, a display of the road view map is automatically transitioned to a display of the satellite view map of the same geographic area, zoomed to a level of 90%.

User interface 224 provides various displays to assist a user in navigating a route.

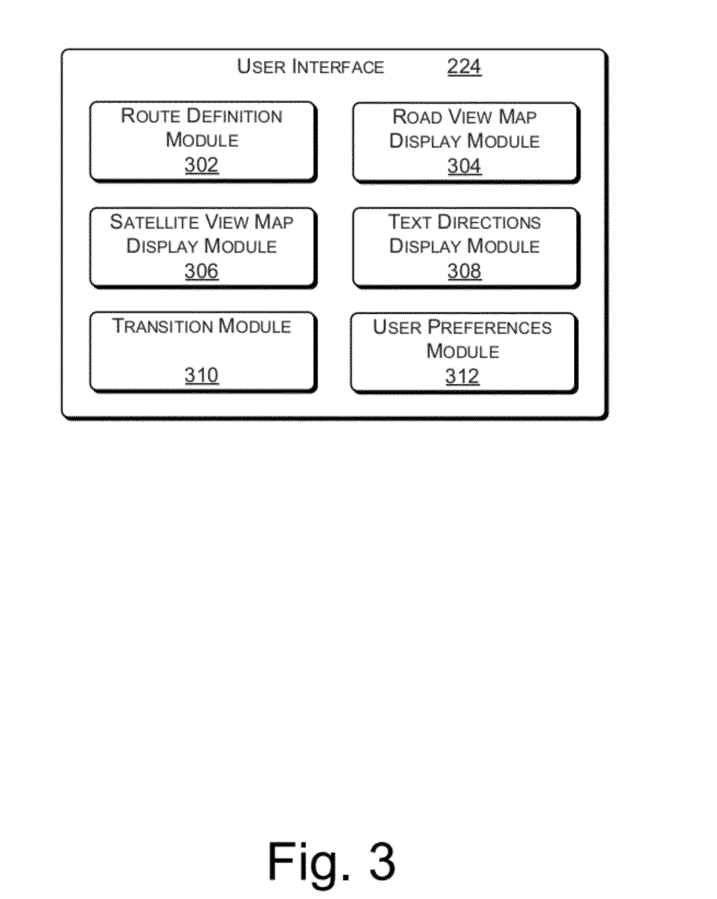

FIG. 3 illustrates select components of example user interface 224, which includes route definition module 302, road view map display module 304, satellite view map display module 306, text directions display module 308, transition module 310, and user preferences module 312. Route definition module 302 provides a display interface through which a user is able to specify a route to be navigated. For example, a user may specify a current location as a starting point, and a particular street address as a destination. Alternatively, the user may also specify one or more intermediate locations to be included along the route. In an example implementation, based on the user-supplied destination information, mobile navigation device 112 communicates with server 102 to determine a specific navigation route. Based on the determined route, mobile navigation device 112 may create a graphical representation of the route on both the road view map 216 and the satellite view map 218, and generate text directions 220. Alternatively, all or part of road view map 216, satellite view map 218, and text directions 220 may be downloaded, specifically for the determined route, from the server 102 to the mobile navigation device 112.

Road view map display module 304 presents a display of the determined route on the road view map 216. Similarly, satellite view map display module 306 presents a display of the determined route on the satellite view map 218, and text directions display module 308 presents a display of the determined route in text form.

Transition module 310 manages the transitions between a road view map display, a satellite view map display, and a text directions display. For example, as described above with reference to FIG. 1, when a user selects a particular location on a route displayed on a road view map or a satellite view map, the display transitions to a text directions display. Additionally, when a road view map display is zoomed in to a particular zoom level, the display transitions from the road view map display to a satellite view map display.

User preferences module 312 provides an interface display through which a user can specify one or more preferences. For example, a user may be able to specify whether or not the user interface is to automatically transition between the road view map and the satellite view map based on the zoom level. Furthermore, a user may be able to specify a particular zoom level at which the display is to transition from the road view map to the satellite view map. In an example implementation, the user-specified transition zoom level may be expressed in terms of a percentage. Alternatively, the user may specify a distance from a destination for the transition. For example, if the use specifies one mile, then regardless of the zoom percentage level, the map display will transition when the current location of the mobile navigation device 112 is within one mile of the destination.

Although illustrated in FIG. 2 as being stored in memory 206 of mobile navigation device 112, navigation application 210, or portions thereof, may be implemented using any form of computer-readable media that is accessible by mobile navigation device 112. Furthermore, in alternate implementations, one or more components of operating system 208, navigation application 210, and other applications 212 may be implemented as part of an integrated circuit that is part of, or accessible to, mobile navigation device 112.

Computer-readable media includes, at least, two types of computer-readable media, namely computer storage media and communications media.

Computer storage media includes volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device.

In contrast, communication media may embody computer readable instructions, data structures, program modules, or other data in a modulated data signal, such as a carrier wave, or other transmission mechanism. As defined herein, computer storage media does not include communication media.

### Example Operation

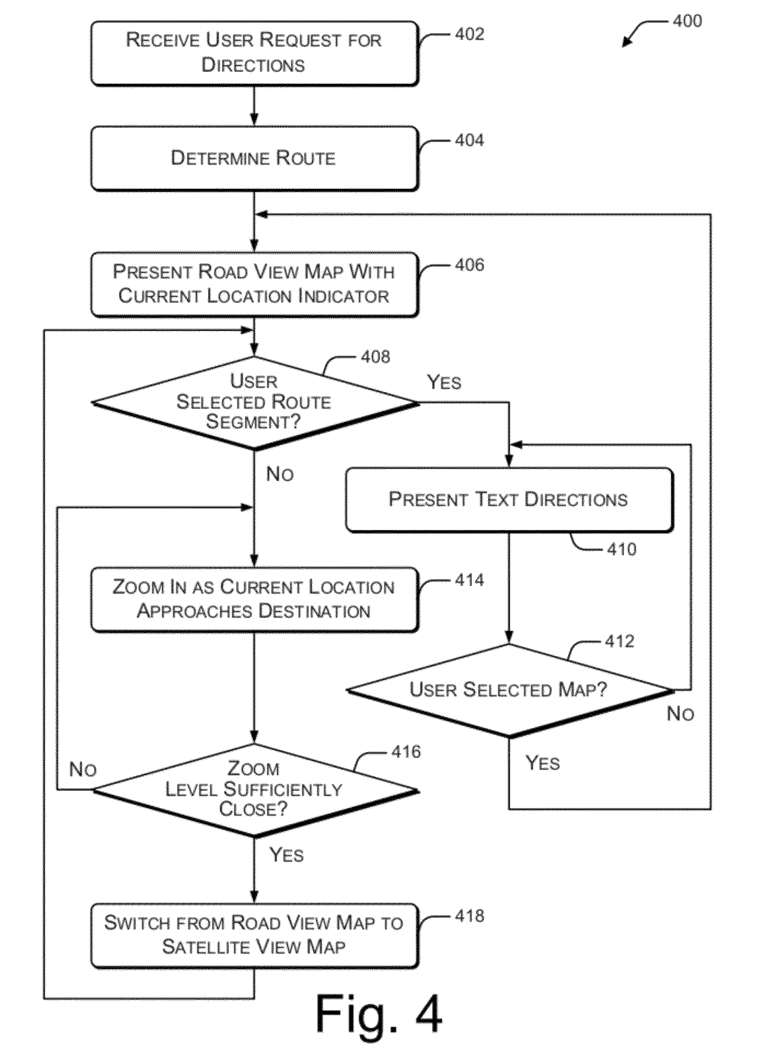

FIG. 4 illustrates an example process 400 for providing a navigation user interface as described herein. This process is illustrated as a collection of blocks in a logical flow graph, which represents a sequence of operations that can be implemented in hardware, software, or a combination thereof. In the context of software, the blocks represent computer-executable instructions stored on one or more computer storage media that, when executed by one or more processors, cause the processors to perform the recited operations. Note that the order in which the process is described is not intended to be construed as a limitation, and any number of the described process blocks can be combined in any order to implement the process, or alternate processes. Additionally, individual blocks may be deleted from the process without departing from the spirit and scope of the subject matter described herein. Furthermore, while this process is described with reference to the mobile navigation device 112 described above with reference to FIGS. 1-3, other computer architectures may implement one or more portions of this process, in whole or in part.

At block 402, a user request for directions is received. For example, through the route definition module 302 of user interface 224, a user may input a destination address, requesting that a route be determined from a current location to the destination address. Alternatively, a user may input both a starting location (which may be different from a current location) and a destination, requesting that a route be determined from the specified starting location to the specified destination.

At block 404, a route is determined. For example, mobile navigation device 112 may send a starting location and a destination to server 102, requesting route data for navigating between the two locations. In response to the request, server 102 may provide route information, which may include, for example, a road view map, a satellite view map, and/or text-based directions.

Alternatively, based on the user specified starting location and destination, GPS module 214 may determine a route, generating a route to be overlaid on road view map 216 and satellite view map 218, and generating text directions 220.

At block 406, a road view map with a current location indicator is presented. For example as illustrated in FIG. 1, display screen 116 may be presented, showing a route between the specified starting location and destination overlaid on a road view map.

At block 408, a determination is made as to whether or not a user has selected a particular route segment on the map display. For example, as illustrated in FIG. 1, when a map view is displayed, a user can select a particular segment of the displayed route, as illustrated by the circle-X on display screen 116.

If it is determined at block 408 that the user has selected a particular route segment (the “Yes” branch from block 408), then at block 410, text directions are presented. For example, transition module 310 transitions user interface 224 from road view map display module (or satellite view map display module) to text directions display module. In an example implementation, when the text directions are displayed, the selected route segment is highlighted, displayed prominently, or otherwise indicated. The selected route segment is indicated even if the selected route segment does not correspond to a current location of the mobile navigation device 112.

At block 412, a determination is made as to whether or not a user has selected a user interface element to return to a map view. For example, as illustrate in FIG. 1, in display screen 118, if a user selects the map at the top of the display screen, the display transitions to display screen 120, returning to the road view map. If the user has not made a selection to return to a map display (the “No” branch from block 412), the processing continues as described above with reference to block 410. On the other hand, if the user has made a selection to return to a map display (the “Yes” branch from block 412), then processing continues as described above with reference to block 406.

If, at block 408, it is determined that the user has not selected a particular route segment (the “No” branch from block 408), then at block 414, the road view map display is zoomed in as the mobile navigation device's current location approaches the destination. For example, the transition between display screen 122 and 124 of FIG. 1 illustrates the road view map being zoomed in as the current location moves closer to the destination.

At block 416, a determination is made as to whether or not the current zoom level is sufficiently close to trigger a transition to a satellite view map. For example, as described above with reference to FIG. 3, transition module 310 monitors a current zoom level, and determines when the current zoom level meets a threshold level for transition. If it is determined that the current zoom level is not sufficiently close (the “No” branch from block 416), then processing continues as described above with reference to block 414.

If it is determined at block 416 that the current zoom level is sufficient to trigger a transition to a satellite view map (the “Yes” branch from block 416), then at block 418, transition module 310 causes user interface 224 to transition from a road view map display to satellite view map display.

Processing then proceeds as described above with reference to block 408.

### CONCLUSION

Although the subject matter has been described in language specific to structural features and/or methodological operations, it is to be understood that the subject matter defined in the appended claims is not necessarily limited to the specific features or operations described. Rather, the specific features and acts are disclosed as example forms of implementing the claims.

What is claimed is:

1. A method comprising:
displaying a navigation route from a starting location to a destination, the navigation route being shown on a road view map;
receiving a user-submitted selection of a particular segment of the navigation route; and
in response to receiving the user-submitted selection of the particular segment of the navigation route, presenting text-based directions for navigating the route, with a portion of the text-based directions that corresponds to the particular segment of the navigation route prominently displayed.

2. A method as recited in claim 1, wherein presenting the text-based directions comprises:
displaying a first area that includes the text-based directions; and
simultaneously displaying a second area that, when selected, causes the navigation route to be displayed on a map view.

3. A method as recited in claim 2, wherein the second area comprises a portion of the road view map.

4. One or more computer readable media encoded with computer-executable instructions that, when executed, configure a mobile navigation device to perform a method as recited in claim 1.

5. A navigation application at least partially stored in memory and executed on a processor to perform a method as recited in claim 1.

6. A method comprising:
displaying a navigation route from a starting location to a destination, the navigation route being shown on a displayed road view map;
modifying the displayed road view map to zoom in on a particular geographic area;
determining that a degree to which the displayed road view map is zoomed in exceeds a threshold zoom level; and
in response to the determining, displaying at least a portion of the navigation route on a displayed satellite view map of the particular geographic area.

7. A method as recited in claim 6, further comprising displaying a current location indicator on the road view map based on a current GPS location of a mobile navigation device.

8. A method as recited in claim 6, wherein modifying the displayed road view map to zoom in on a particular geographic area comprises:
displaying a current location indicator on the road view map based on a current GPS location;
adjusting a position of the current location indicator on the road view map as the current GPS location changes;
zooming the displayed road view map such that the particular geographic area that is displayed includes both the current GPS location and the destination.

9. A method as recited in claim 6, wherein modifying the displayed road view map to zoom in on a particular geographic area comprises receiving a user-submitted request to zoom in on the displayed road view map.

10. A method as recited in claim 6, wherein zoom levels are expressed as percentages.

11. A method as recited in claim 10, wherein 0% is a wide angle view and 100% is a close up view.

12. A method as recited in claim 6, wherein the threshold zoom level is preconfigured.

13. A method as recited in claim 6, wherein the threshold zoom level is user-configurable.

14. One or more computer readable media encoded with computer-executable instructions that, when executed, configure a computer system to perform a method as recited in claim 6.

15. A navigation application at least partially stored in memory and executed on a processor to perform a method as recited in claim 6.

16. A system comprising:
a processor;
a memory communicatively coupled to the processor; and
a navigation application at least partially stored in the memory and executable on the processor, the navigation application including:
a road view map;
a satellite view map;
text directions;
a zoom manager to maintain a zoom level threshold; and
a user interface to display the road view map and the satellite view map;
a transition module of the user interface to:
transition between displaying the road view map and displaying the satellite view map when a current zoom level crosses the zoom level threshold;
transition from displaying the road view map to displaying the text directions when a user selects a segment of a navigation route displayed on the road view map; and
transition from displaying the satellite view map to displaying the text directions when a user selects a segment of a navigation route displayed on the satellite view map.

17. A system as recited in claim 16, the navigation application further including a GPS (global positioning system) module to track a current location of the system.

18. A system as recited in claim 17, wherein the user interface further displays an indicator of the current location on the road view map or the satellite view map.

19. A system as recited in claim 16, wherein the user interface further displays a navigation route on the road view map or the satellite view map.

20. A system as recited in claim 16 implemented as a mobile phone.
